(19) United States
(12) Patent Application Publication
(10) Pub. No.: US 2025/0102189 A1
(43) Pub. Date: Mar. 27, 2025

(54) Dual Axis Solar Collector Array

(71) Applicant: Exowatt, Inc., Miami, FL (US)

(72) Inventors: Hannan PARVIZIAN, Miami, FL (US); Sushrut BAPAT, Miami, FL (US)

(21) Appl. No.: 18/900,027

(22) Filed: Sep. 27, 2024

Related U.S. Application Data
(60) Provisional application No. 63/585,808, filed on Sep. 27, 2023.

(51) Int. Cl. F24S 23/30; F24S 30/00; F24S 30/40

(52) U.S. Cl. CPC F24S 23/30; F24S 30/40; F24S 2030/11

(57) ABSTRACT

A rugged Fresnel lens panel support structure and associated first and second linear actuators changes the orientation of the panels in two degrees of freedom (azimuth and elevation) to track the changing position of the sun.

### CROSS-REFERENCE TO RELATED APPLICATION

Benefit is claimed from U.S. provisional application No. 63/585,808 filed Sep. 27, 2023, incorporated herein by reference for all purposes as if expressly set forth.

### FIELD

The technology herein relates to collecting thermal energy, and to solar collectors that collect solar energy to produce electrical and/or thermal output power. More particularly, the technology relates to a solar thermal collector arrangement providing a simple rugged mechanical structure that moves the collectors in two axes to track the position of the sun.

### Background & Summary

We all know the sun rises in the cast and sets in the west. We also know the times the sun rises and sets are based on the time of year and our location on the earth's surface. For example, days grow shorter in the northern hemisphere as the winter solstice approaches and they grow longer as we approach the summer solstice. Meanwhile, in the southern hemisphere it is just the opposite—as the days are growing longer in the northern hemisphere they are growing shorter in the southern hemisphere and vice versa. There are always twelve hours of daytime and twelve hours of night-time at the equator, except for two minor effects that increase daytime by about eight minutes. Most of us probably vaguely know these changes have to do with the tilt of the earth relative to the sun which is responsible for changing seasons in the northern and southern hemispheres.

Yet, the path the sun takes in the sky is actually a bit more complicated. For example, the sun takes an arc across the southern sky from locations north of the equator and takes an arc across the northern sky from locations south of the equator. The exact angle and arc depends on the latitude of the observer and the time of year.

Not only is the earth tilted on its axis relative to the sun, but the earth is also orbiting the sun in a path that is elliptical rather than circular. Orbiting in an ellipse doesn't just mean that the Earth is closer to or farther from the Sun at certain points in its orbit. It also—by Kepler's second law—means that when the Earth is close to the Sun (perihelion), it possesses a faster orbital speed, and when the Earth is far from the Sun (aphelion), it possesses a slower orbital speed. The effects together mean that during the course of a year, if you took the sun's position every day at the same time from a given location on the earth's surface, you would see that the sun traces an analemma or figure eight in the sky. We can intuitively understand this by remembering that the angle of light during the winter seems to be different (the sun's arc is lower in the sky in the northern hemisphere and higher in the sky in the southern hemisphere) than the angle of light during the summer.

Meanwhile, the Earth doesn't rotate exactly once on its axis every 24 hours. Instead, the Earth makes a full 360° rotation in just 23 hours and 56 minutes. A day takes 24 hours because it takes those extra 4 minutes to “catch up” to the amount of distance the Earth has traveled in its orbit around the Sun. During an average day, when the Earth moves at its average speed around the Sun, 24 hours is just right. But when the Earth moves more slowly (near aphelion), 24 hours is too long for the Sun to return to its same position, and so the Sun appears to shift more slowly than average. Similarly, when the Earth moves more quickly (near perihelion), 24 hours isn't quite long enough for the Sun to come back to where it started, and so it shifts more quickly than average. All this makes for a complex but very predictable path the sun will take across the sky on any given day of the year at any given location on the earth's surface but which will change from one day to the next See e.g., Siegel, “This Is How The Sun Moves In The Sky Throughout The Year” (Forbes 2019), www.forbes.com/sites/startswithabang/2019/01/01/this-is-how-the-sun-moves-in-the-sky-throughout-the-year/?sh=48c77e7a7303; FIGS. 9, 10.

Meanwhile, a solar collector should optimally be aimed directly at the sun in order to maximize the energy it collects. This is why some solar collectors are designed to track the sun's position in two axes. Ideally, the solar collector should track in two degrees of freedom (azimuth and elevation) so it can aim precisely at the sun's position. For example, FIG. 9 shows that the sun's position changes in both azimuth and elevation as it traces a path across the sky from dawn to dusk. Two different actuators or adjustments (one for the azimuth, another for the elevation) can be controlled independently to move the solar collector to the precise orientation it needs to be in to aim at the sun. A computer including a real time clock/calendar can automatically control the position of the collector so it frequently updates its orientation as the sun moves across the sky.

While the theory of automatic solar tracking is straightforward, a challenge is to construct solar collection platforms, support frames, actuators, and controllers for solar collectors that are rugged, reliable, efficient and inexpensive. This problem gets worse as the size and number of solar collectors increase in order to increase thermal collection capacity.

### BRIEF DESCRIPTION OF THE DRAWINGS

FIG. 1 is a side elevated perspective view of an example dual axis solar collector array system comprising two array platforms each comprising multiple arrays of Fresnel lens optical solar concentrators.

FIG. 2 shows another perspective view of the example array system.

FIG. 3 shows a side elevated view of one of the array platforms.

FIG. 4 shows a side perspective view showing the solar components set to a different elevational orientation and also showing ducting/piping and thermal load such as a thermal storage.

FIG. 5 shows an end perspective view.

FIG. 6 shows an end elevated perspective view.

FIG. 7 shows a detail including an absorber array.

FIG. 8 shows an example automatic controller.

FIG. 8A shows a flowchart of an example process the controller performs based on stored instructions.

FIG. 9 shows different paths the sun traces in the sky depending on time of year.

FIG. 10 shows an analemma the sun traces in the sky over the course of a year.

FIGS. 11A, 11B, 11C are together a flip chart animation showing East-West 1^{st} axis tracking.

FIGS. 12A, 12B, 12C, 12D, 12E, 12F, 12G are together a flip chart animation showing 2^{nd} axis (e.g., elevation) tracking.

### DETAILED DESCRIPTION OF NON-LIMITING EMBODIMENTS

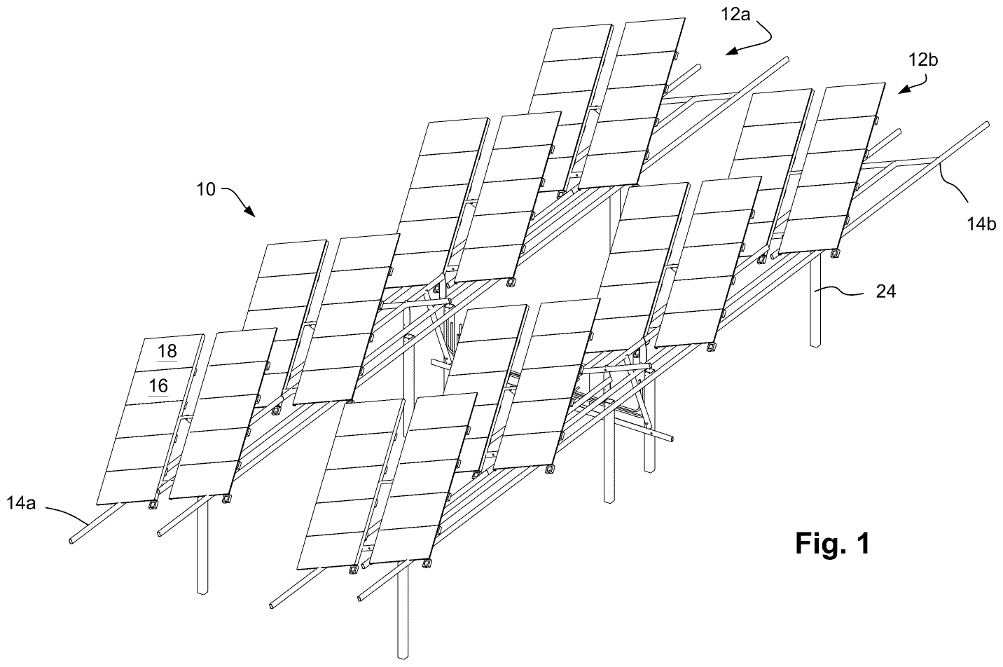

FIG. 1 shows an example perspective view of a solar collector array system 10 moveable in two degrees of freedom (dual axis) to follow the position of the sun.

As shown in the drawing, the array system 10 includes two array structures 12a, 12b. Each array structure 12 (the array structures may be identical or similar in some embodiments) comprises a horizontal frame 14 that holds or suspends a number of long panel arrays 16. Each panel array 16 in turns comprises a number of Fresnel lens panes 18. The Fresnel lens panes 18 each receive solar rays from the sun and diffract or bend (concentrate) the solar rays to respective thermal and/or optical collection or absorber devices 20.

The Fresnel lens panes 18 can be made of glass, polycarbonate plastic, acrylic plastic or any other suitable material. See e.g., Xie et al, “Concentrated solar energy applications using Fresnel lenses: A review,” Renewable and Sustainable Energy Review Volume 15, Issue 6, August 2011, Pages 2588-2606, doi.org/10.1016/j.rser.2011.03.031. In the example shown, the Fresnel lens panes 18 can be of any shape, size and dimensions. Each Fresnel lens pane 18 may comprise for example a grating etched onto a surface of a rectangular pane of glass disposed in a frame, which focuses (diffracts) sunlight into a point. An example of a suitable Fresnel lens pane 18 is described in U.S. patent application Ser. No. 29/961,987 filed Sep. 9, 2024, incorporated herein by reference.

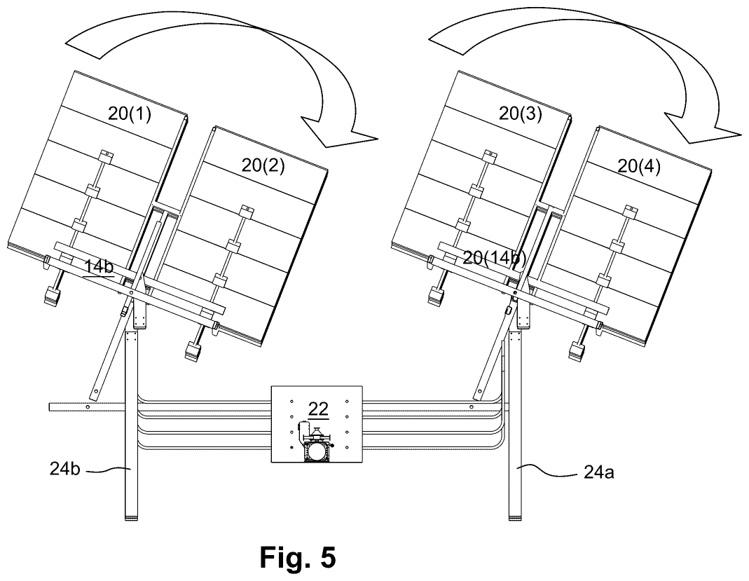

In the example shown, a number (e.g., 5) Fresnel lens panes 18 are mounted together in a long rectangular frame to form a sub-array 16. Thus, in FIG. 1, there are 16 such rectangular subarrays 16, each frame containing 5 Fresnel lens panes 18, for a total of 80 Fresnel lens panes 18. Other numbers and configurations of panes are possible in other embodiments. Each pane focuses thermal energy on a respective absorber 20, which in the example embodiments are movable with the sub-arrays 16 to ensure correct focal distance and focal position. The absorbers 20 may be thermally coupled to a heat circulation system 22 via ducts or pipes (see FIG. 5) that removes collected heat from the absorbers and transports it to another place such as to a thermal storage and/or a thermal load.

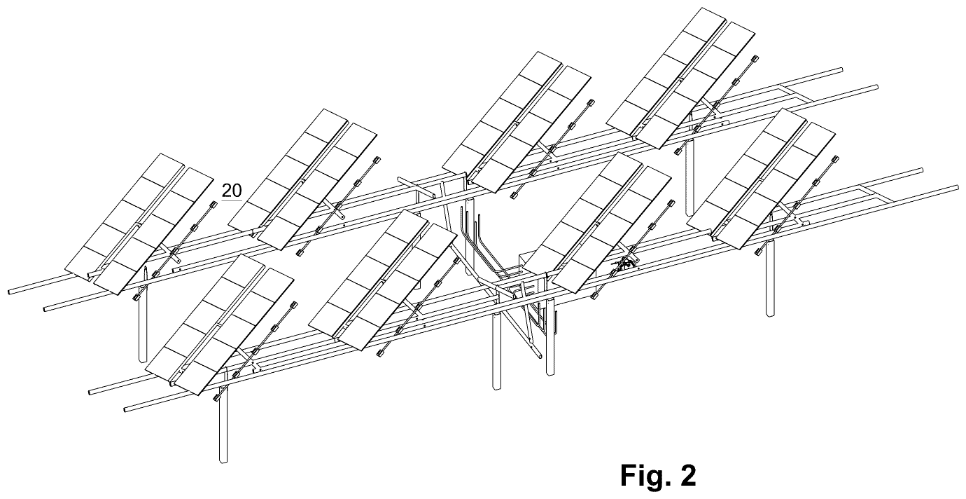

In the example shown, the Fresnel lens panels are mounted to tubular frames 14 that are supported by upright posts 24 that may for example extend vertically from the ground or other surface such as other equipment. In particular, as can be seen in FIG. 2, each frame 14 may comprise a rectangular open frame structure including a plurality of cylindrical rodlike elements (which may be tubular or solid) and arranged in a rectangular configuration. In one embodiment there can be three such longitudinal rods connected together and spaced apart by cross-rods, but many such cylindrical rodlike elements may be used as needed to adequately support the Fresnel lens panels. Crosspiece rodlike structures hold the frame structure together and strengthen it.

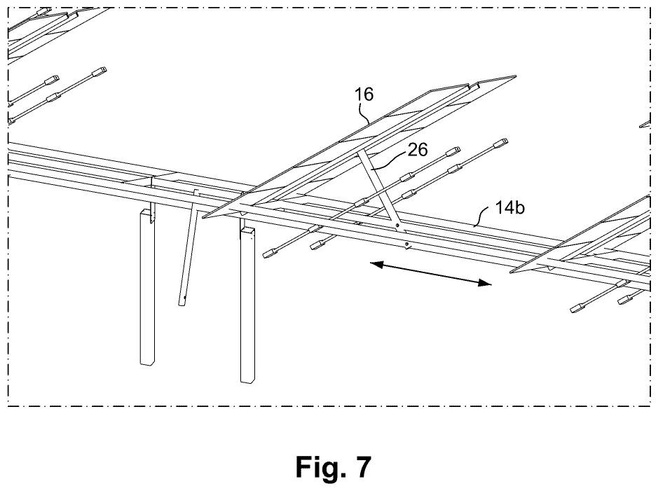

FIG. 5 further shows that the frames 14 are pivotally mounted to the vertical posts so their orientation may be rotated relative to the posts 24. In particular, angled guides attached to the frames (see FIG. 7) are mechanically coupled to a first linear horizontal positioning element that can rotate the frame 14 about its longitudinal axis under the effect of a first linear mechanical actuator. In example embodiments, a linear mechanical actuator is used for ruggedness and simplicity. As the horizontal position element is moved in the direction to the left or right as shown in FIG. 5, it causes the frames 14 to rotate about their longitudinal axes, i.e., about a roll axis that is normal to the plane of FIG. 5. The structure shown is ganged so several such angled guides may be connected to the common first horizontal position element and rotate together (along with the absorber arrays) with longitudinal movement of the first horizontal position element.

FIG. 5 also shows an array of associated absorber structures 20 onto which the lens panes 18 respectively focus light. Appropriate flexible ducting or other head transport mechanisms are provided to transport heat from the absorbers 20 to a thermal load such as a thermal battery, a thermal load, etc.

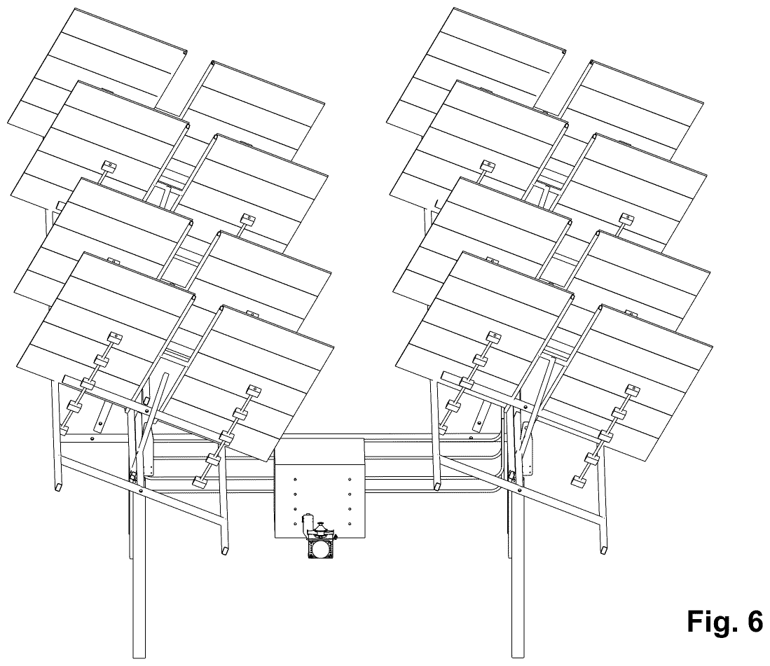

The first horizontal position element thus retains the frame structures and the Fresnel panes 18 in a current orientation and then can change the orientation of the frames 14 (i.e., pivot them by a variable amount about pivot points attaching them to the upright posts) to change their rotational orientations relative to the horizon based on movement/position of the actuator. As shown in FIGS. 5, 6 & 7, a common angled guide can be used to change/control the orientation of a long frame structure, and several different frame structures can be ganged and thus moved together with the first horizontal position element. In addition, the first horizontal positioning element and associated first linear actuator provides a locking force and substantial momentum to retain the solar panels and associated frame in its current (set) orientation despite wind and other effects that might otherwise move the panels.

In particular, FIGS. 5 and 6 thus shows that the first horizontal positioning element can rotate left and right in the perspectives of these figures to tilt or rotate the collector panels by 180 degrees or nearly 180 degrees of roll about an axis that is normal to the plane of these figures. See also FIG. 1 which shows the panel orientations rotated at an angle relative to vertical. In the embodiment shown, in one embodiment a first linear actuator is used to move and position the first horizontal positioning element for its simplicity and ruggedness but other embodiments can use other kinds or types of actuators.

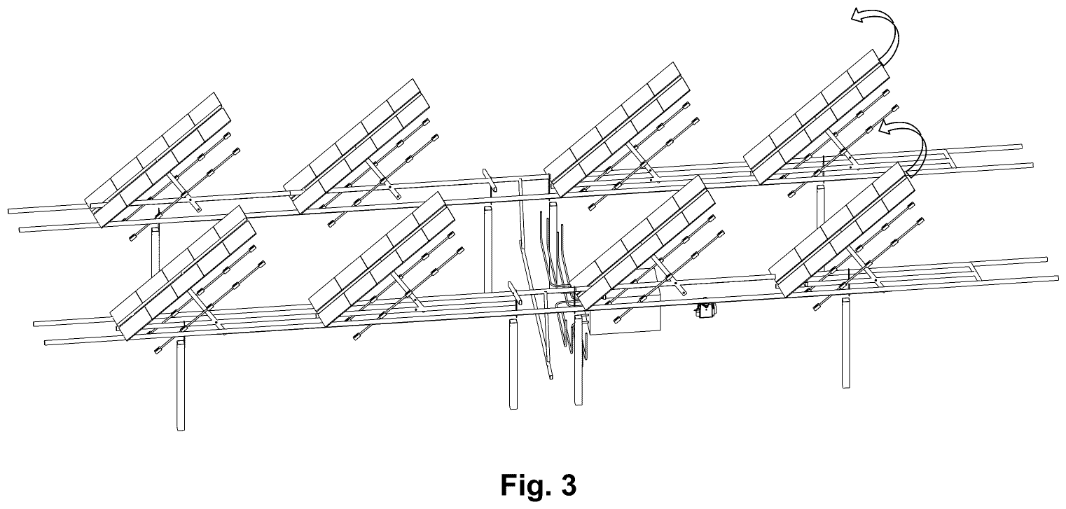

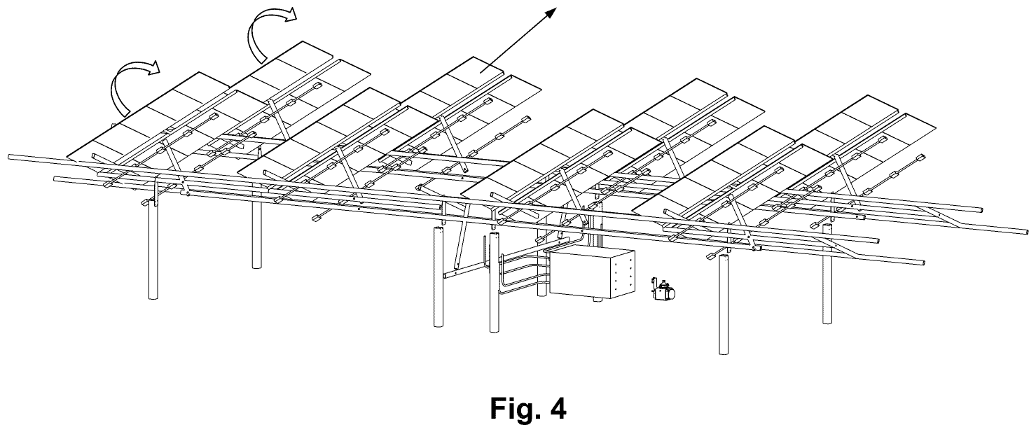

FIGS. 2-4 show a second horizontal positioning element ganged to the solar collection frames 16. This second horizontal positioning element can be used in the embodiment shown to position/change the elevational orientation of the solar collection frames 16 relative to the horizon, i.e., the direction from horizontal or vertical of the common axes normal to the solar panel surfaces. For example, in one embodiment, the second horizontal positioning element and associated second linear actuator can change the direction from horizontal or vertical of the common axes normal to the solar panel surfaces to any desired angle between pointing at the horizon to pointing directly overhead-thereby changing the elevational orientation of the panels from for example vertical to horizontal. In the embodiment shown, in one embodiment a second linear actuator is used to move and position the second horizontal positioning element for its simplicity and ruggedness but other embodiments can use other kinds or types of actuators. Such movement is accomplished e.g., by longitudinally moving frames 14 along their longitudinal axis to change the pitch orientation of each of subarrays 16 from nearly vertical to nearly horizontal (compare for example FIG. 2 with FIG. 4). Sliding frames 14 longitudinally forwards and backwards (see FIG. 7) through action of the angular support 26 (which are pivotally mounted at one end to a respective subarray 16 and to a respective frame 14) causes the subarrays to simultaneously change their elevational positions much like pool deck chairs can change orientational position from fully “sitting up” to fully reclined.

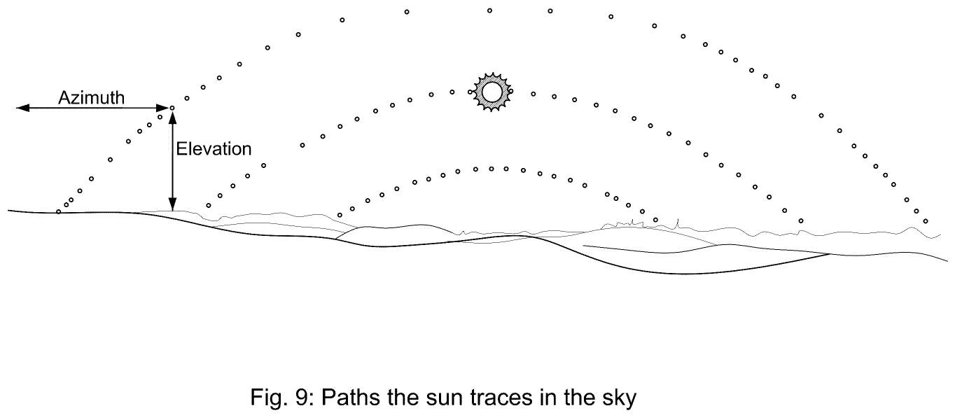

Note the this elevational adjustment is independent of the roll rotational adjustment shown in FIG. 5, such that the example design shown can change the orientations of subarrays 16 in two independent degrees of freedom. However, these two orientation rotations can be used together to control both the azimuthal and the elevational position of normal vectors (see FIG. 4) from each Fresnel lens pane 18—and thus the incidence angle of the sun's rays onto those panes. This allows example embodiments to adjust the orientations of all of the Fresnel lens panes 18 simultaneously to track the sun's position as it traces a path across the sky on a given day and from one day to the next (see FIGS. 9, 10, FIGS. 11A-11C, and FIGS. 12A-12G.

In example embodiments, slewing drives, rotational drives, or other kinds of drives may be used as actuators to position the subarrays and associated ganging structure to a desired orientation and retain the subarrays and ganging structure in that orientation until it is desired to move them to a different orientation.

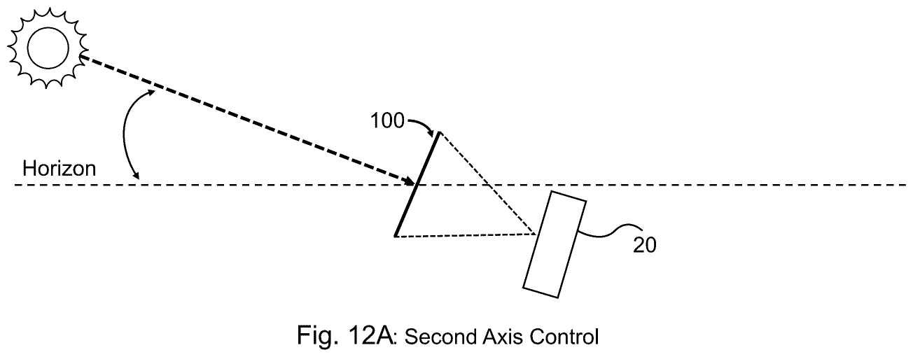

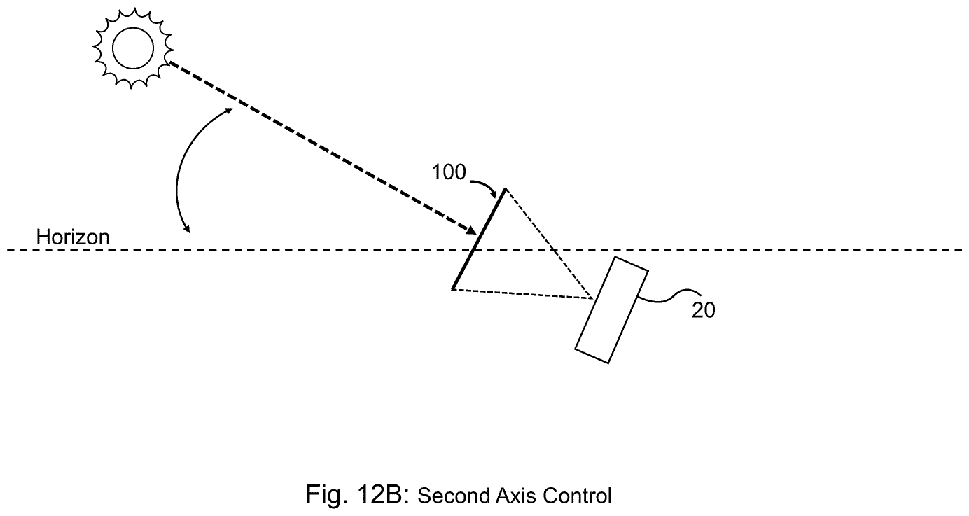

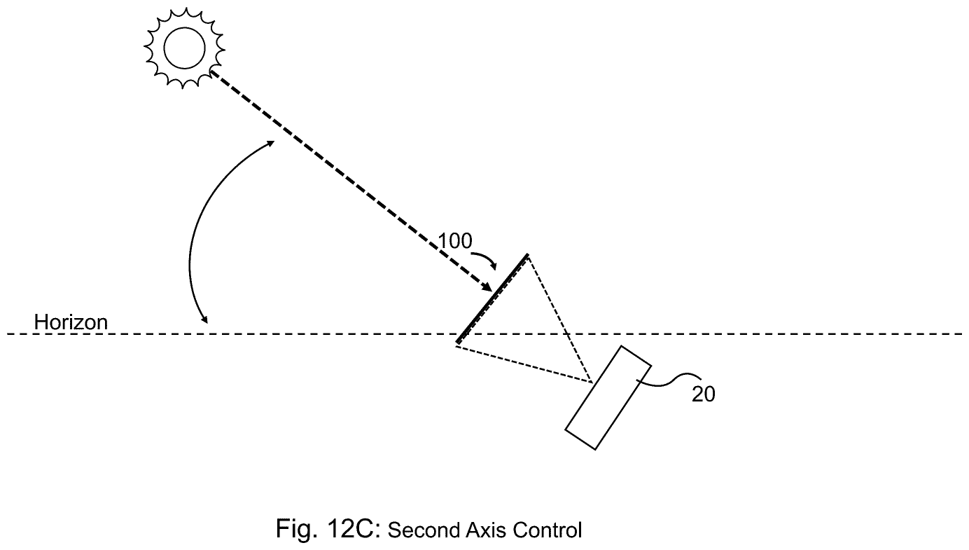

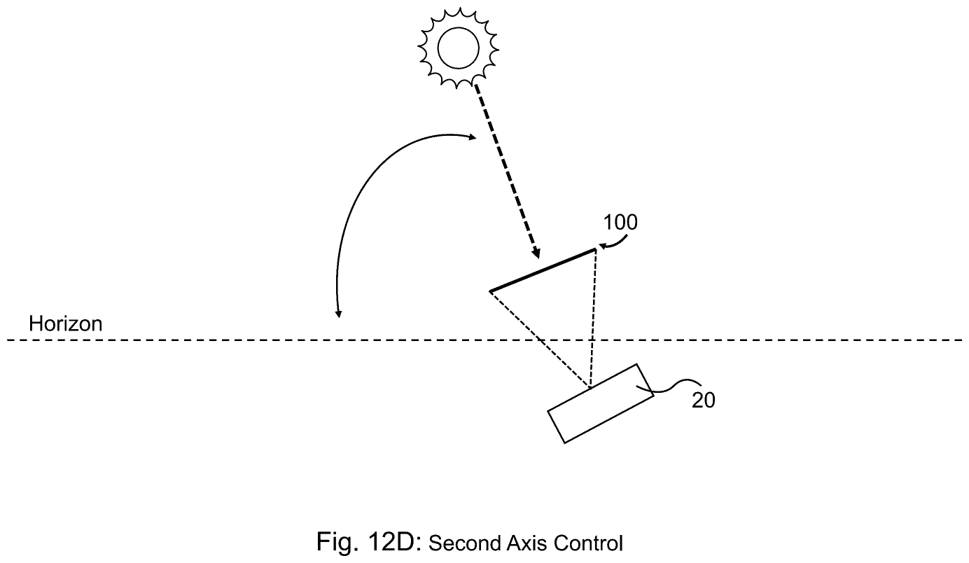

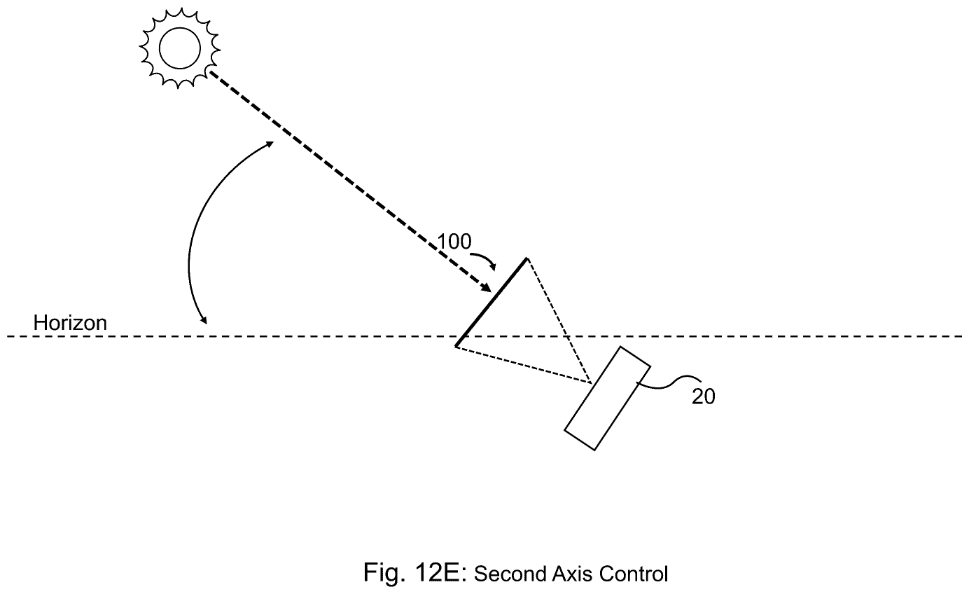

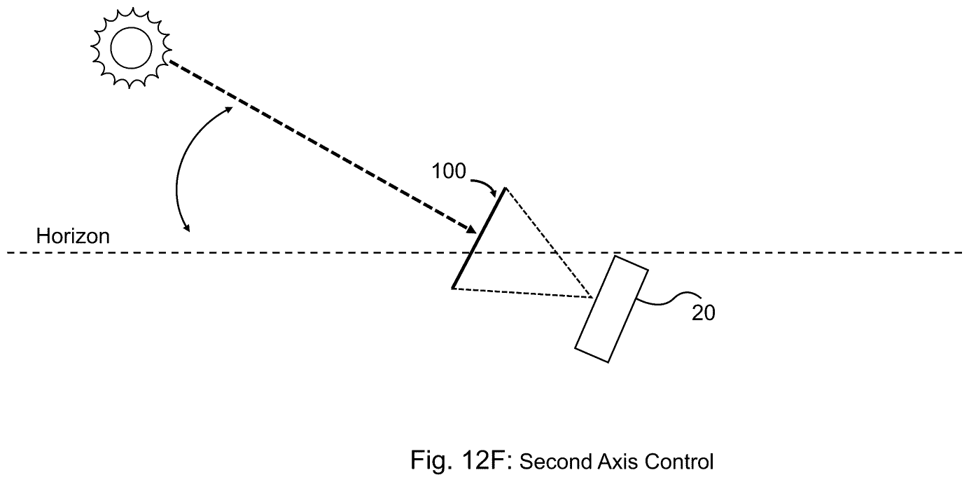

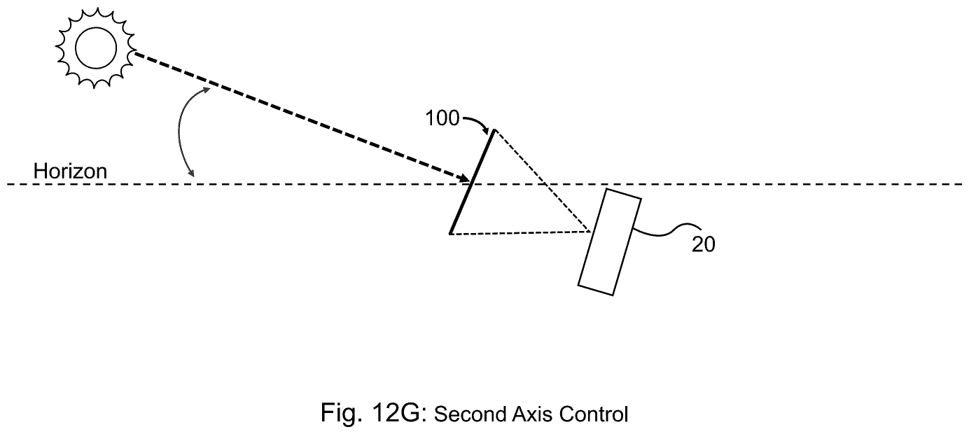

As will be understood, this mechanism is structured to aim an axis normal to the solar collection panes 18 to any number of different pointing directions within a hemisphere of the sky by controlling the positions of the first and second horizontal positioning elements using the associated first and second linear actuators or other drives, respectively. Such common axes will trace elevation from the horizon to directly overhead by moving the second horizontal positioning element (see FIGS. 12A-12G), and will trace azimuth potentially from 0 degrees to 180 degrees (with 90 degrees straight ahead) by moving the first horizontal positioning element to thereby rotate the panels with their long edges being horizontal in a first orientation to their long edges being vertical to their long edges being horizontal in a second orientation different from the first orientation (see FIGS. 13A-13C). In this way, a controller that controls each of the first linear actuator and the second linear actuator can point the entire array at any desired position within a hemispherical sky that encompasses all possible positions of the sun from a given latitudinal location on the earth's surface. In example embodiments, this becomes possible with the simple two-axis orientation settings described above because the optical elements are planar-meaning that the entire array does not have to be repositioned in two dimensions as might be required for example with a parabolic reflector or collector.

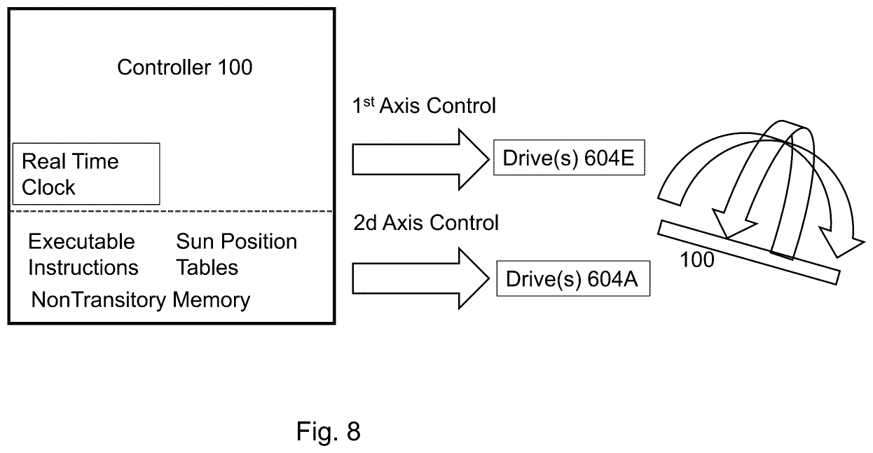

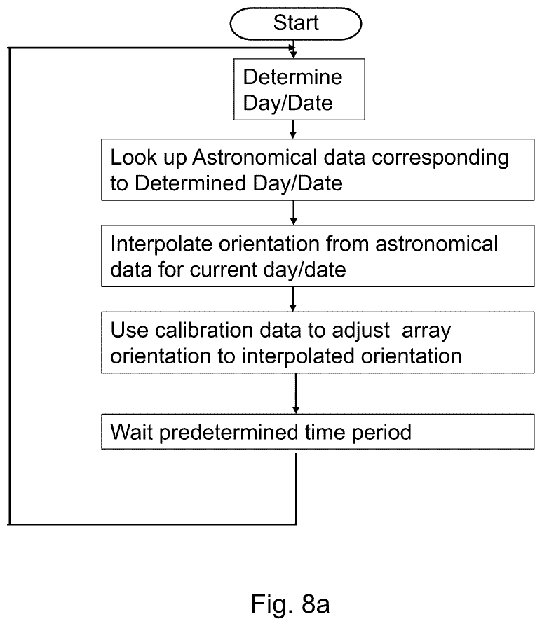

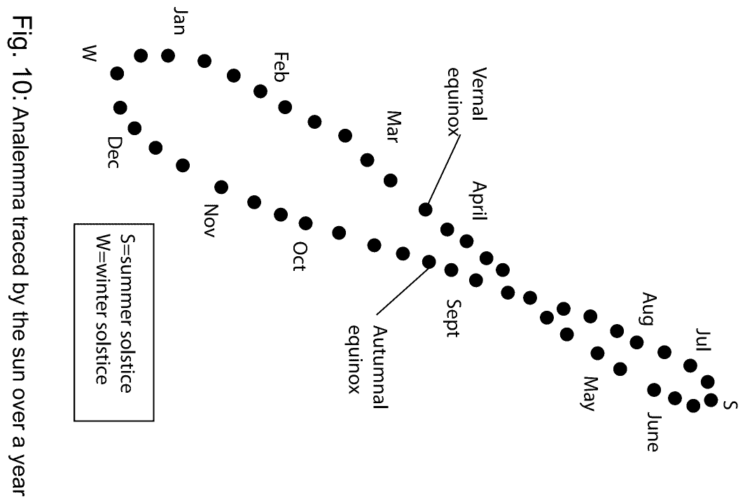

In one embodiment, the vertical posts are installed in a suitable direction (compass bearing or azimuth) based on the latitude of the collector installation. Then, the first and second actuators set the position of the first and second horizontal positioning elements based on the time of day, the day of the year and the latitude of the installation (as programmed into a computer or controller) to track the sun's position as it moves across the sky. As discussed above and shown in FIG. 9, the sun's position at a given time of day will trace an arc across the sky and a figure eight in the sky (see FIG. 10) over the course of a year; the controller 100 shown in FIG. 8 takes this into account in controlling the first and second linear actuators 604E, 604A to positions of the first and second horizontal position elements, respectively. The controller 100 is also able to position the Fresnel lens array in a vertical or other resting orientation during the night and at other times when solar collection is not possible. For example, in some embodiments, the controller 100 may include a wind speed and wind direction detector (or receive localized such information from a weather monitoring and/or prediction source over a network) to position the solar collection array in a suitable orientation that reduces likelihood of wind damage and/or reduces or minimizes vibration due to wind.

In one embodiment, the system is calibrated based on the particular installation orientation of the solar collection array relative to the surface of the earth so an electronic controller can perform a lookup in a table (the angular contents of which depends on latitude) based on (a) time of day and (b) day of year, to position the first and second horizontal positioning actuators so the solar panels are aimed at the current position of the sun. The controller can control the first and second linear actuators to change their respective positions once every few minutes to track the sun's changing position. For example, the lookup table may contain linear actuator positions that correlate with spherical or polar coordinates specifying the sun's angular position in the sky at the installation's particular latitude based on time of day and day of the year. The controller 100 may thus include a real time clock/calendar that indexes the lookup table to determine the correct linear positions of the first and second linear actuators. In one embodiment, respective linear position sensors or encoders may be used to sense linear positions of the first and second linear position actuators (and/or orientations of the solar panels or associated carrying frame structures) to ensure accurate positioning. The lookup table the controller 100 stores may include data points such as shown in FIGS. 9, 10 for the particular latitude the system is installed at. As shown in FIG. 8A, the controller 100 may interpolate between such stored sun positions based on the current date/time of day to determine a particular orientation for a particular day and time of day at that particular latitude. The controller 100 may then control the first and second actuators (based on calibration data, and using position sensors in one embodiment for a closed loop feedback control system) to bring the panes 20 to orientations that cause the sun's rays to be normally incident on the surfaces of the panes. The controller 100 may repeat this process after a wait time (e.g., 5 minutes) to adapt to the sun's changing position in the sky.

In one embodiment, the system is thus calibrated based on the particular installation orientation of the solar collection array relative to the surface of the earth so an electronic controller (see FIG. 8) can perform a lookup in a table (the angular contents of which depends on latitude) based on (a) time of day and (b) day of year and (c) calibration parameters, to control the actuators so the solar panels are aimed at and follow the current position of the sun. The controller 100 can control the actuators 604E, 604A to change their positions once every few minutes to track the sun's changing position. For example, the lookup table may contain actuator positions that correlate with spherical or polar coordinates specifying the sun's angular position in the sky at the installation's particular latitude based on time of day and day of the year. The controller 100 may include a real time clock/calendar that indexes the lookup table to determine the correct linear, slew and/or rotational position of the actuators. In one embodiment, a position sensor or encoder may be used to sense position of the actuator (and/or orientations of the solar panels or associated carrying frame structures) to ensure accurate positioning in a closed loop system. In the example shown, two drives 600E, 600A drive the frames 14 discussed above to provide achieve such orientations, taking into account in some cases that orientation of the panes 18 is a function of both independent adjustments (which may not translate into angle of elevation and angle of orientation, but which instead may be a function of both a first adjustment and a second adjustment).

As shown in FIG. 2, the underside of the frame structure and/or the Fresnel panels may further provide a suspended array of solar collectors 20. Each solar collector 20 in the array is positioned at the focal point of at least one corresponding Fresnel solar collection panes 18. Thus, as the solar panes 18 change their (common) orientation, the solar collectors 20 similarly change their orientation so the solar energy refracted by each Fresnel lens remains focused on a corresponding collector. In one embodiment, the solar collector or absorbers 20 may comprise for example thermal collectors that collect thermal energy and provide such collected thermal energy to a thermal load such as a thermal storage device, a thermal engine, or other arrangement that uses and/or stores thermal energy. In other example embodiments, the solar collectors could comprise solar light collectors or collectors that collect both thermal energy and light.

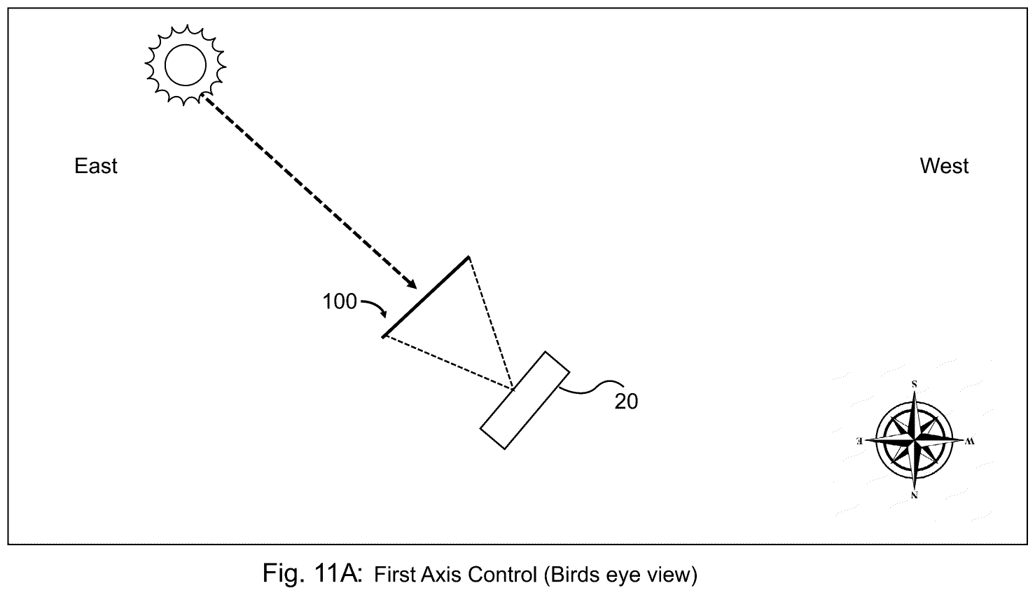

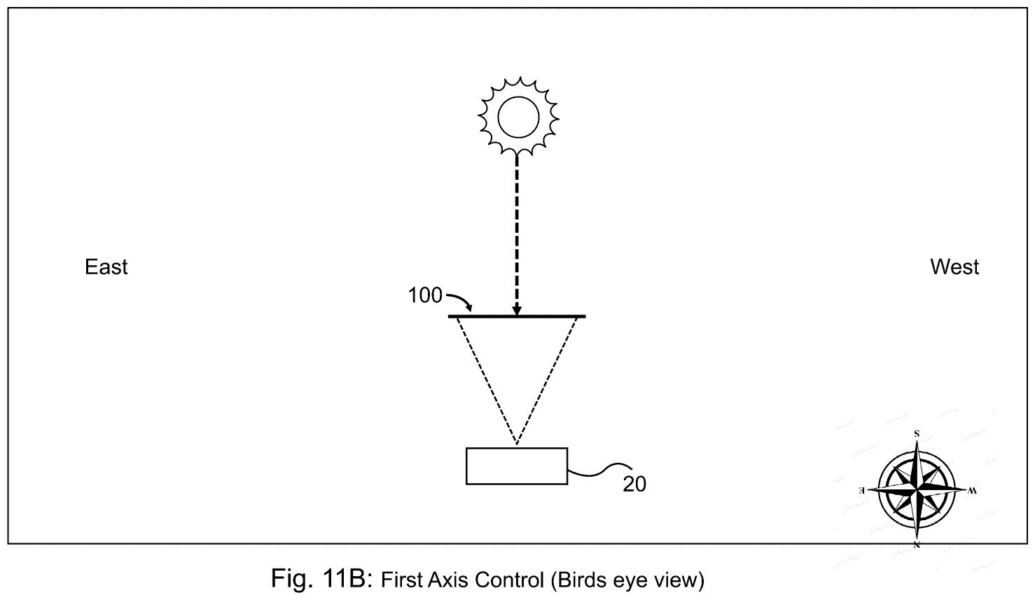

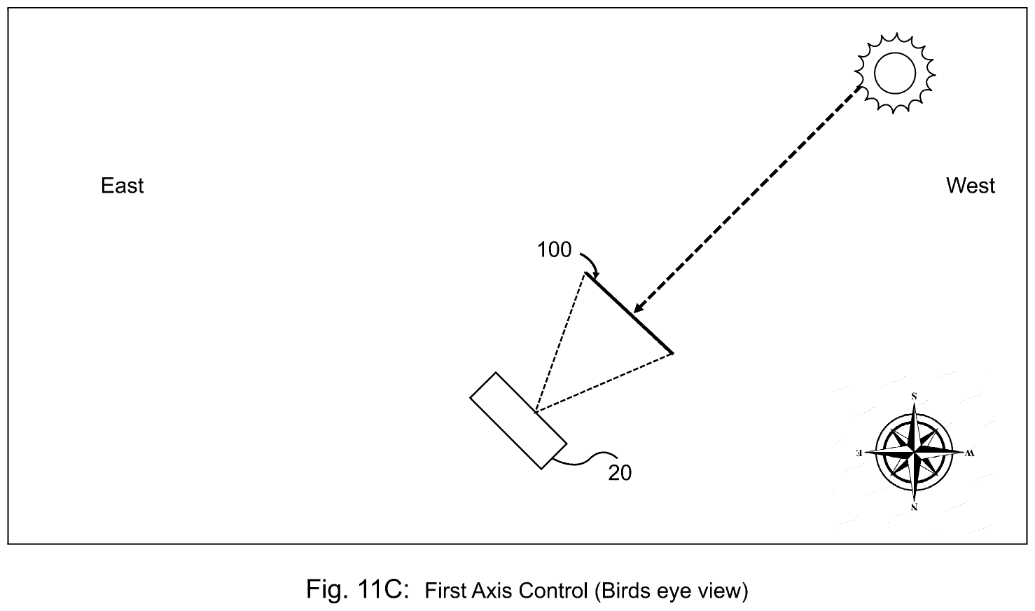

FIGS. 11A, 11B, 11C are together a flip chart animation showing an example of how the controller changes the orientation of a solar panel as the sun moves in azimuth from east to west in the sky. FIGS. 12A, 12B, 12C, 12D, 12E, 12F, 12G are together a flip chart animation that shows an example of how the controller changes the orientation of a solar panel as the sun changes elevation in the sky. In nearly all situations, the sun moves in both ways at the same time, so the controller 100 of FIG. 8 will at the same time provide the FIG. 11A/11B/11C orientation change and the FIG. 12A et. seq. orientation change to control orientation change of the solar panels in two degrees of freedom simultaneously.

All patents and publications cited herein are incorporated by reference as if expressly set forth.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A solar collection array comprising:
a first plurality of lens panels mounted to a first support member;
a second plurality of lens panels mounted to a second support member;
a first ganging structure that gangs the first support member and second support member together;
a first drive that controllable moves the first ganging structure to change orientation of the first plurality of lens panels and the second plurality of lens panels in a first degree of freedom; and
a second drive and associated second ganging structure that controllably moves the first plurality of lens panels and the second plurality of lens panels to change orientation thereof in a second degree of freedom.

2. The solar collection array of claim 1 further including:
a third plurality of lens panels mounted to a third support member; and
wherein the second ganging structure gangs the first support member and third support member together;
wherein the second drive is mechanically coupled to the second ganging structure.

3. The solar collection array of claim 1 further including an electronic controller connected to the first drive and to the second drive, the electronic controller selectively controlling the first drive and the second drive to drive the first plurality of lens panels and the second plurality of lens panels to a common orientation such that light rays emitted by the sun and incident to the first plurality of lens panels and the second plurality of lens panels are normal to surfaces of the first plurality of lens panels and normal to surfaces of the second plurality of lens panels.
